(19) United States
(12) Patent Application Publication
(10) Pub. No.: US 2004/0101337 A1
(43) Pub. Date: May 27, 2004

(54) Printer

(76) Inventors: Michel Woodman, Huntingdon (GB); David Block, El Cerrito, CA (US)

Correspondence Address: JONES DAY, 51 Louisiana Aveue, N.W, WASHINGTON, DC, 20001-2113, US

(21) Appl. No.: 10/275,874

(22) PCT Filed: May 11, 2001
(86) PCT No.: PCT/GB01/02077

(30) Foreign Application Priority Data
May 12, 2000 (GB) 0011547.7

(51) Int. Cl. B41J 11/44

(52) U.S. Cl. 400/76

(57) ABSTRACT

A printer comprises a printing mechanism arranged to print an image on an image receiving medium, wireless receiver means for receiving image data for printing on said image receiving medium. The wireless receiver means is arranged to receive signals having a frequency of the order of Gigahertz.

The present invention relates to a printer.

In the state of the art, a number of printers capable of “direct” printing is known. Direct printing in the context of embodiment of the present invention means that the printer is placed on the image receiving medium, usually manually, and the printing means of the printer or the entire printer then scans over the image receiving medium in the printing operation. Thus, the medium is not fed through the printer—as in most office printers—but the printer moves over the medium.

Such a printer is known from EP 564297 A. The printer has an ink jet printhead which is scanning in two orthogonal directions over the image receiving medium, onto which the printer is placed manually. The printer is connected to a computer and capable eg. of printing addresses onto envelopes, but can also be used separately from the computer for printing data downloaded from the computer to the printer.

Another ink jet printer to be placed on a printing medium is disclosed in U.S. Pat. No. 5,634,730. This printer is provided with a keyboard for data inputting, but can also print images downloaded from a computer. The print head scans over the image receiving medium along a special path, eg. helically or like a pendulum.

DE 3142937 A refers to a so-called hand stamp which is placed manually on the image receiving medium. It can print data downloaded from an accounting machine, or images consisting of user-selected fixed phrases. The hand stamp has a thermal print head and an ink ribbon for printing.

According to a first aspect of the present invention, there is provided a printer comprising a printing mechanism arranged to print an image on an image receiving medium; wireless receiver means for receiving image data for printing on said image receiving medium, wherein said wireless receiver means is arranged to receive signals having a frequency of the order of Gigahertz.

According to a second aspect of the present invention, there is provided a printer comprising a printing mechanism arranged to print an image on an image receiving medium; wireless receiver means for receiving image data for printing on said image receiving medium, wherein said wireless receiver means is arranged to receive signals in accordance with the Bluetooth standard.

According to a third aspect of the present invention, there is provided a printer comprising a printing mechanism arranged to print an image on an image receiving medium; wireless receiver means for receiving image data for printing on said image receiving medium, wherein said wireless receiver means is arranged to receive time and/or date information for printing on said image receiving medium.

According to a fourth aspect of the present invention, there is provided a printer comprising a printing mechanism arranged to print an image on an image receiving medium; wireless receiver means for receiving image data for printing on said image receiving medium, wherein said wireless receiver means is arranged to receive bar code information for printing on said image receiving medium.

According to a fifth aspect of the present invention, there is provided a printer comprising a printing mechanism arranged to print an image on an image receiving medium; wireless receiver means for receiving image data for printing on said image receiving medium, wherein said wireless receiver means is arranged to receive serial information for printing on said image receiving medium.

According to a sixth aspect of the present invention, there is provided a printer comprising a printing mechanism arranged to print an image on an image receiving medium; wireless receiver means for receiving image data for printing on said image receiving medium, wherein said wireless receiver means is arranged to receive postage information or a frank for printing on said image receiving medium.

For a better understanding of the present invention and as to show how the same may be carried into effect, reference will now be made to the accompanying drawings in which:

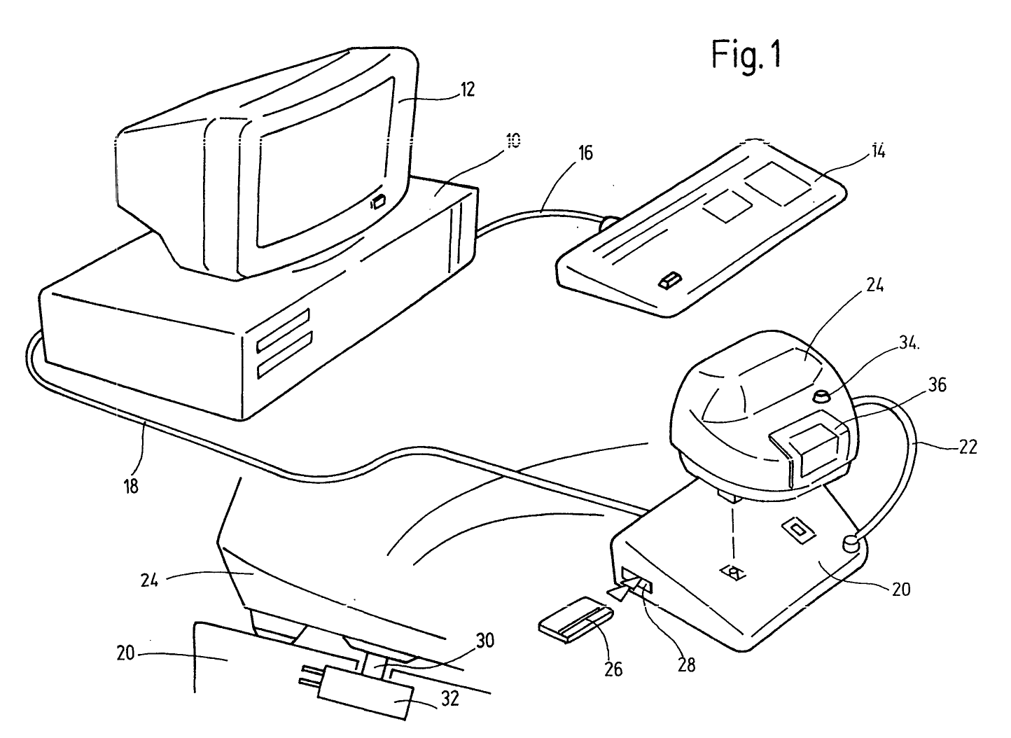

FIG. 1 is a plan view showing a printer, a base station and a computer;

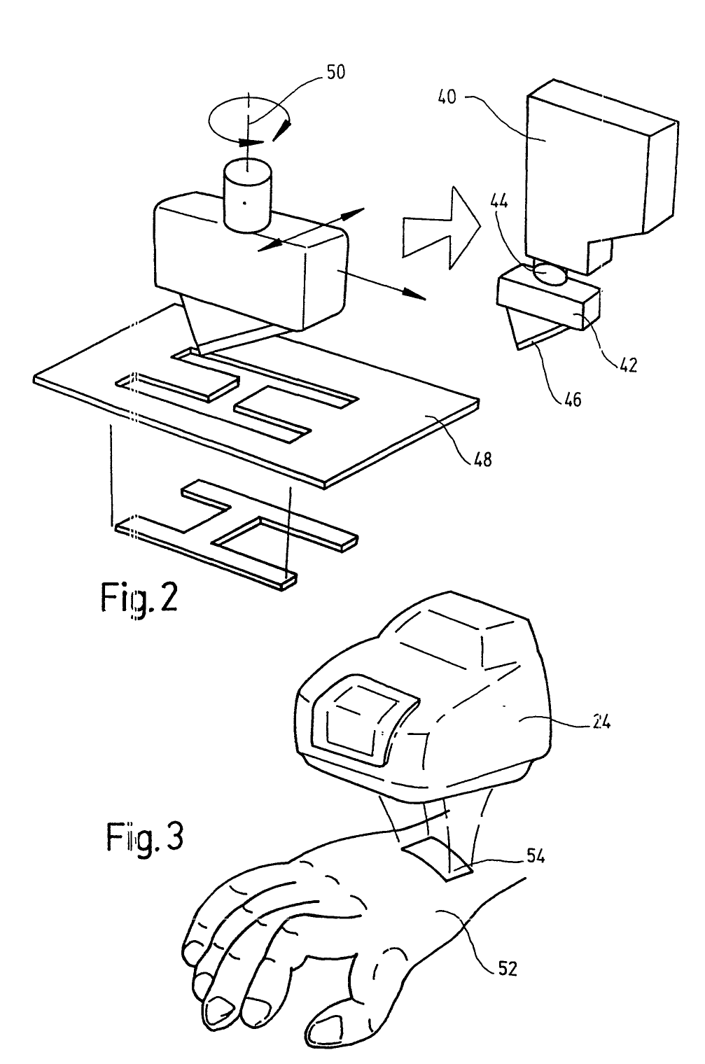

FIG. 2 is a view of a cutter mechanism which is usable instead of the print head of the printer;

FIG. 3 is a view of a printer using a special security ink;

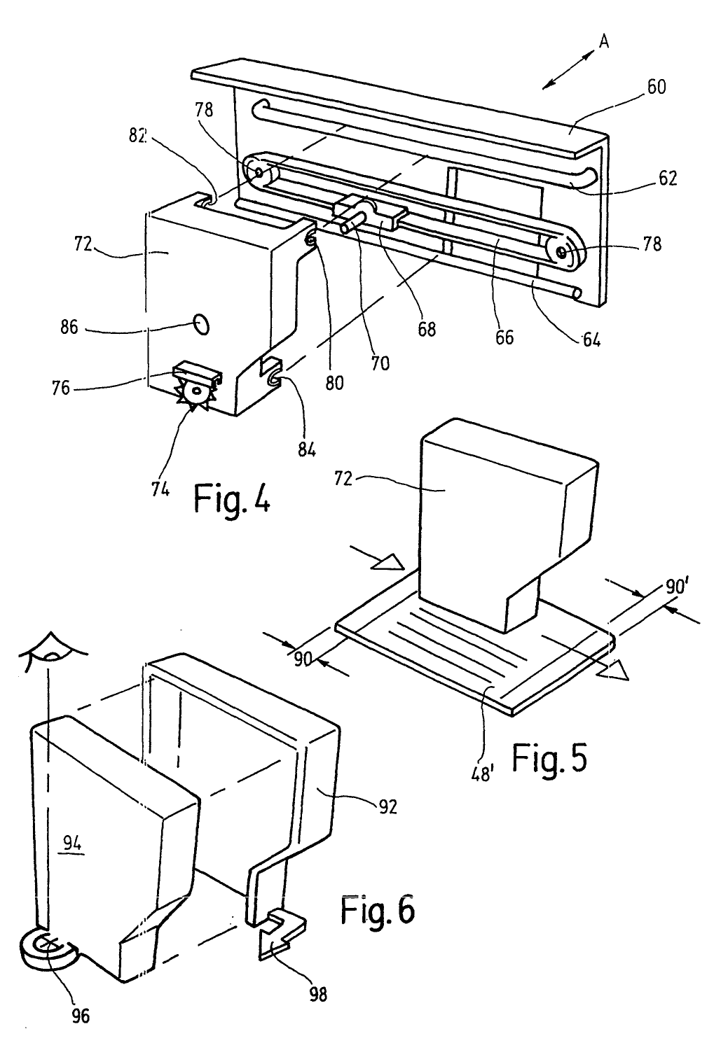

FIG. 4 is a view of a mechanism for fixing the printhead in the printer;

FIG. 5 illustrates the operation mode of the print head;

FIG. 6 is a view of a print head with an alignment feature;

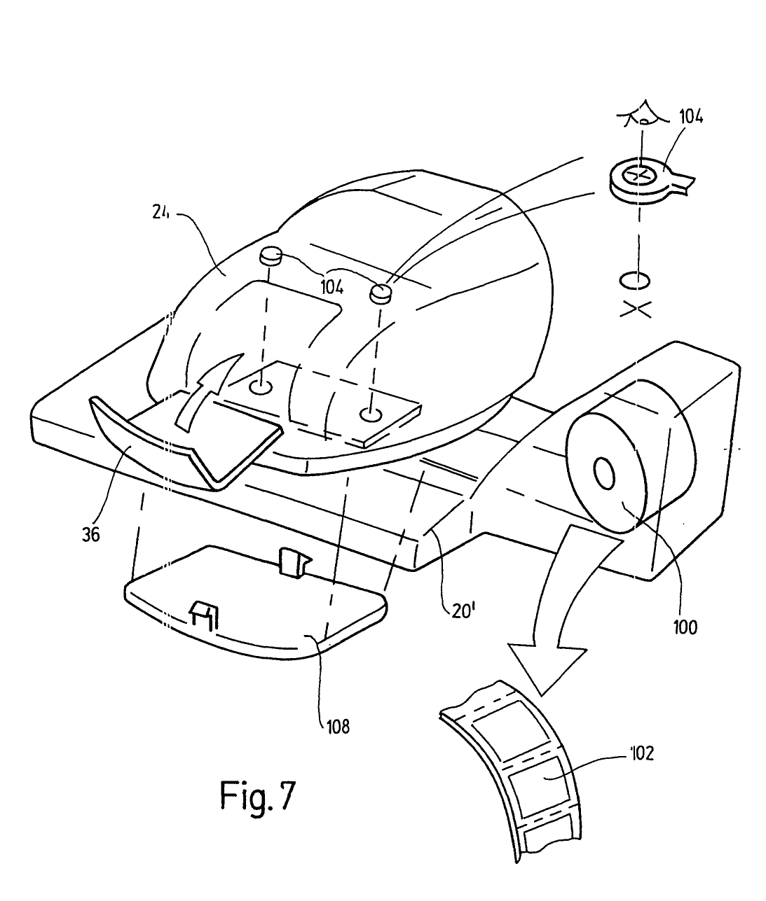

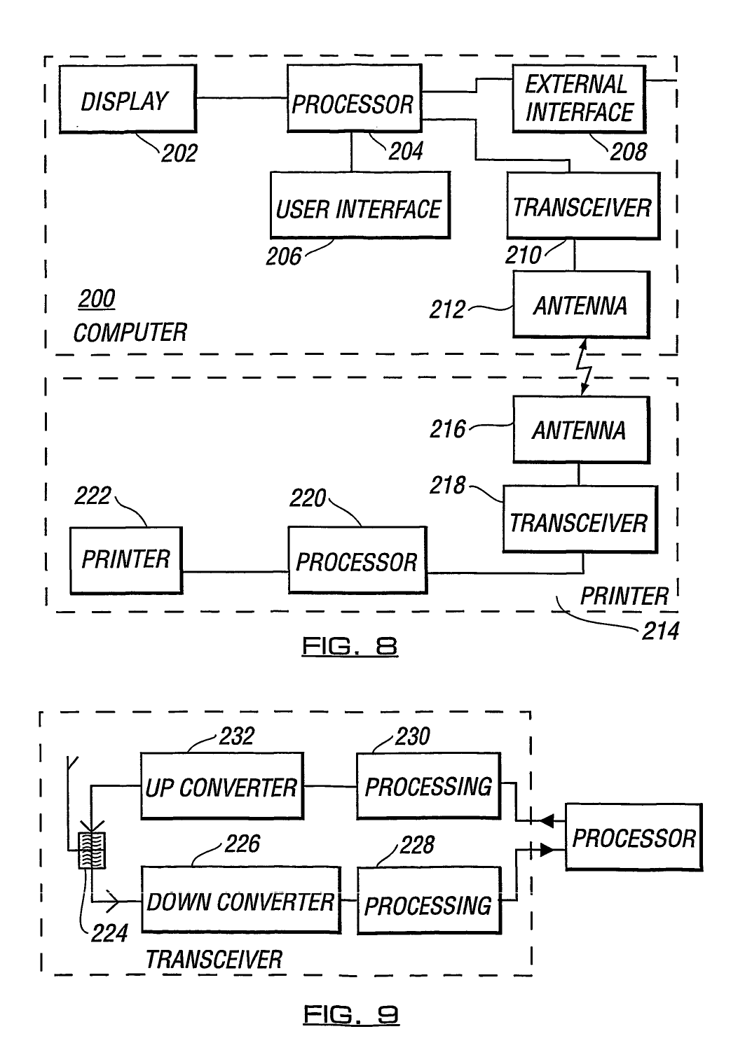

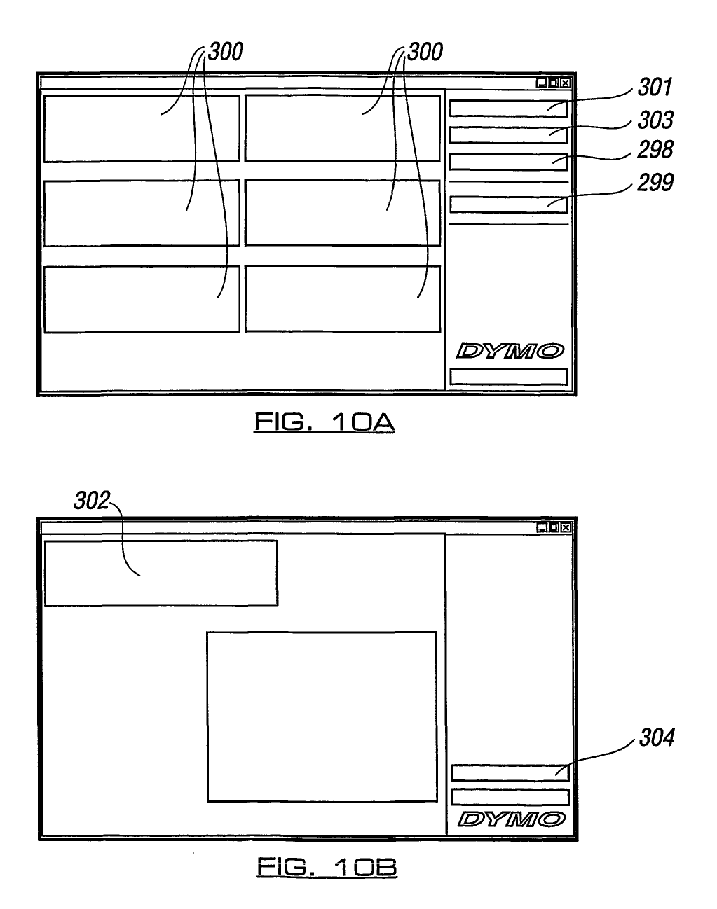

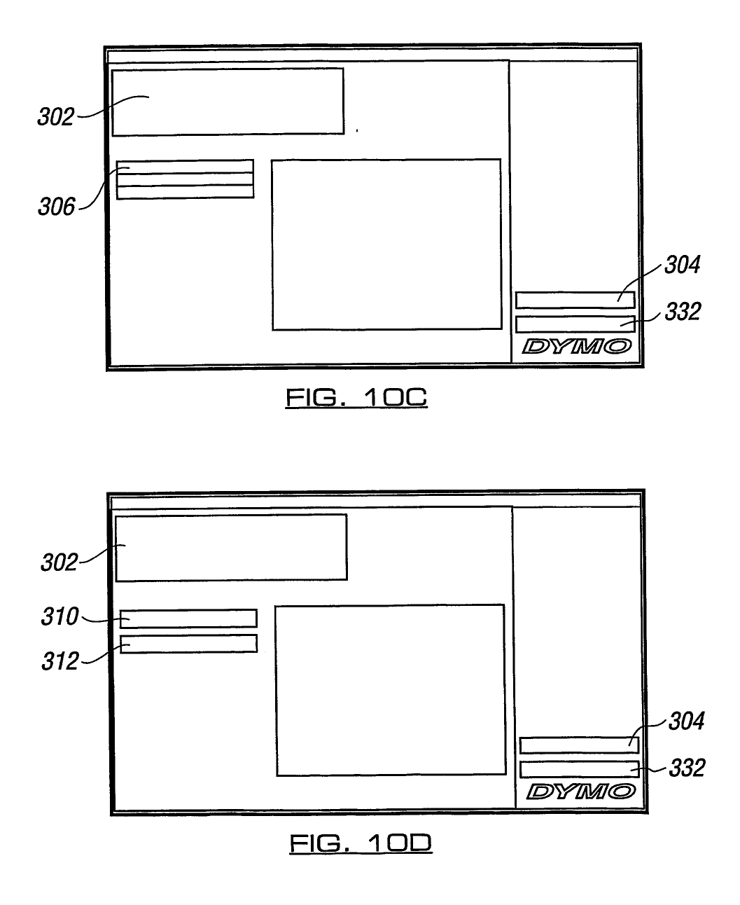

FIG. 7 is a view of the printer mounted on another base station;

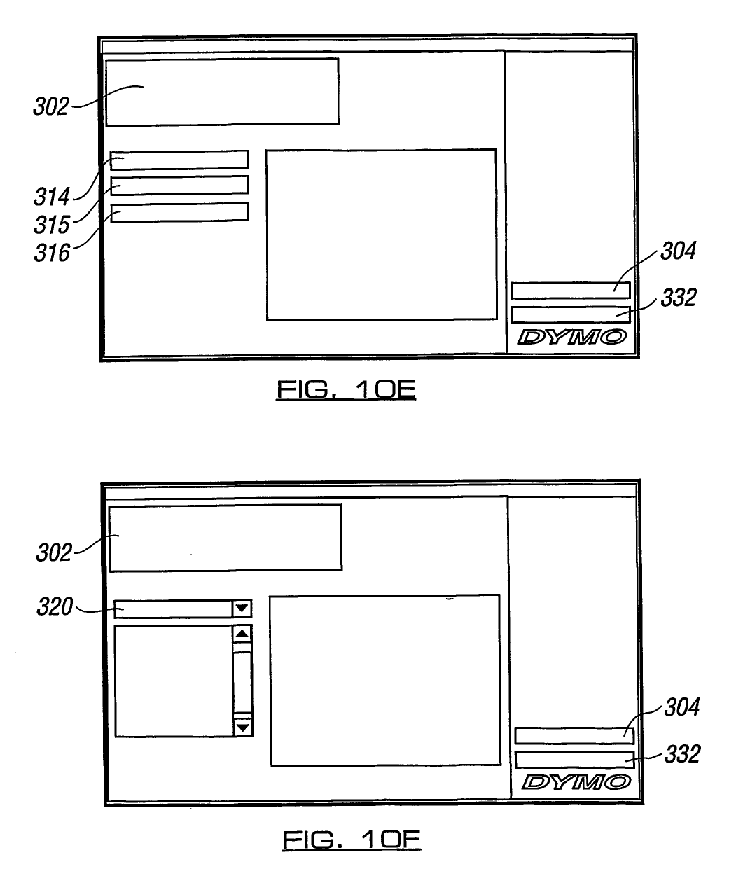

FIG. 8 is a schematic view of a printer and computer arranged to communicated via a wireless connection;

FIG. 9 is a schematic view of a transceiver of FIG. 8; and

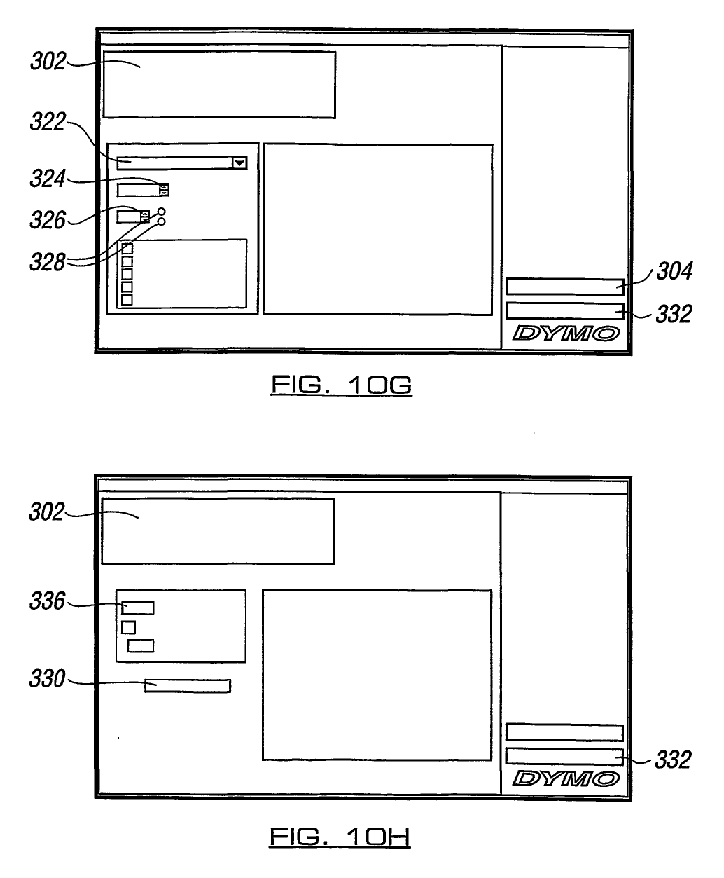

FIG. 10 shows the series of screens that are displayed when designing a stamp.

FIG. 1 shows a printing system consisting of a computer 10, a computer controlled display 12, which is in the described embodiment of the invention a CRT, a keyboard 14 linked to the computer 10 by means of a cable 16, another cable 18, connecting the computer 10 with a base station 20, which is connected to a printer 24 by means of a cable 22. Thus, the printer 24 is linked to the computer 10 via the cables 18,22 and the base station 20.

As known in the prior art, the computer 10 comprises a processor on which software is running, comprising an operating system, a printer driver to enable printing with the printer 24 from the operating system, and a software application by which data can be created, selected and formatted on the PC, for defining image patterns to be printed by the printer 24. The software application can be activated in a number of ways:

selected by the user at startup or from the desktop: the user places the software application in the start up directory or creates an icon on the desktop;

from within another application: the user invokes the software application from a button (displayed on the display 12) in the toolbar of another software application;

from the handheld printer 24 itself: if the application is not running, the user presses a print button 34 on the hand held printer 24, which will automatically invoke the software application in the first instance.

Another possibility to activate the software application on the computer 10 for controlling the printer 24 is to lift the printer 24 off the base station 20. A switch 32 is provided in the base station 24 sensing the presence or absence of the printer 24 by means of a pin 30. When the printer 24 is placed upon the base station, the pin 30 is depressed, and the switch 32 is closed. In the case that the printer 24 is removed from the base station 20, the pin 30 which is biased in the vertical direction moves upwardly and the switch 32 opens. The switch is connected via some electronic circuits to the computer 18 and activates the software application for printing.

The base station 20 is connected to the computer 10 by means of the cable 18, which can be a parallel or a USB cable. Electric power is supplied to the base station 20 by a separate mains transformer, but could also be supplied from the-computer via the cable 18, preferably when the cable 18 is a USB cable. The cable 18 can be hard wired to the base station 20, or connected to a socket of the base station, which is preferably provided at the rear thereof. When the printer 24 is not in use, the handheld printer will be placed in the base station 20. The base station 20 will ensure that the ink jet print head of the printer 24 is protected when not in use by a capping device that will be automatically triggered whenever the printer is inserted into the base station 20. The base station 20 will also cause the print head of the printer 24 to eject ink into a reservoir and mechanically clean the surface of the print head. These measures are necessary to maintain optimum print quality.

The umbilical cable 22 connects the base station 20 to the hand held printer 24, providing both power and data. A LED on the printer will indicate that power is on. The printer 24 is removed from the base station 24 and positioned on the surface to be printed. The length of the cable 22 limits the distance of travel from the base station.

In another embodiment of the invention, the printer is arranged to be disconnected from the base station by unplugging the umbilical cable 22 and moved to another location where printing of the contents of onboard memory, ie. downloaded image data, can be effected. The user will employ scroll buttons on the printer to select the required print data, which appear in a small LCD. Once a selection has been made, pressing the print button 34 will activate printing. Having selected the data to print using the software application (or the scroll buttons on the printer), the user will activate printing from the print button 34 on the hand held printer 24 itself. In yet a further embodiment of the invention, the printer 24 is not connected to the printer. The information which is to be printed by the printer 24 is provided by a memory card, chip or the like. The memory card etc can be inserted into the printer and can be received or bought separately. This will be described in more detail hereinafter.

Print alignment is achieved visually through a transparent window 36 in the printer casing. This window 36 can also be opened for inserting an ink cartridge into the printer 24 before use. The cartridge is then clamped in a carriage of the printer 24. The window 36 must be closed before printing. The user can choose from a range of coloured and special inks. Changing a cartridge is achieved by lifting a retaining lever and extracting the cartridge in use and replacing this with a new or different colour cartridge in the way described above. If the removed cartridge still contains ink and is to be reused it must be capped to avoid the ink drying out.

The printer 24 contains a print mechanism with the ink jet print head having a number of print nozzles, and an ink supply. The print head is moved by means of motor driven scanning means within the housing in two (generally orthogonal) directions such that a rectangular area can be imprinted through an aperture of the printer 24 at the bottom of its housing. Thus, the printer 24 is placed manually on an image receiving medium and—when the print button 34 is depressed—the print head scans over the medium and imprints it by spitting ink droplets onto it. The print button has to be held on for a predetermined time, eg. at least two seconds, to initiate printing (in order to prevent accidental printing).

FIG. 1 shows the printer 24, base station 20 and computer 10 linked by cables. In an embodiment, it is possible to replace one or all of these links by a wireless link such as a low power RF link or an infra red link. FIG. 1 also shows the presence of a “Smart Card” reader 28 in the base station 20. Smart cards 26, ie. memory cards, memory chips or the like may be used for storing data or images or as a substitute for additional RAM in the base station. Spare cards may be stored within the base station where a storage compartment is provided (not shown). The memory card or the like may be in the printer and/or the base station.

In the case that the printer 24 is powered only by batteries, rather than having the cable 22 transmitting power from the base station 20, the amount of charge remaining in the batteries may be monitored and displayed on a display of the printer 24, and/or on the display 12 of the computer 10. If rechargeable batteries are used, the battery monitoring system could also be used to control the charge/discharge cycle of the battery pack to maximise battery life. This could also enable rapid recharging of the batteries. Such a battery management system could also indicate that there was sufficient energy remaining in the battery pack to complete the current task.

As described above, the printer 24 is based on a two dimensional movement of the print head over the image receiving medium. Additional features may be provided to this X-Y motion to perform a range of other functions. For example, the print cartridge could be replaced with a cutter mechanism and then be used for cutting out stencils. This is indicated in FIG. 2. A holder 40 is provided which has the same measurements as an ink jet printhead cartridge, such that it can be mounted in the printer 24 instead of a print cartridge. On the bottom of the holder 40, a blade 46 is provided which is mounted to a brick shaped blade holder 42, and the blade holder 42 is connected with the holder 40 via a shaft 44. Since the holder 40 scans in two orthogonal directions over the medium 48, the blade 46 can also be moved over the medium, which is in the embodiment shown in FIG. 2 a stencil material, in order to cut a desired pattern out of it. Due to the fact that cutting has to be performed along different cutting directions, it is necessary to rotate the cutting blade around an axis 50 lying in a plane defined by the direction of motion of the holder 40. Thus, the blade holder 42 needs to be rotated with respect to the holder 40 around the axis of the shaft 44. This is performed by means of a motor provided in the holder 40. The motor (not shown) is arranged to rotate the shaft 44, via an intermediate gear. The power required by the motor is provided by the printer, via the connections to which the print head is normally connected. Hence, the holder 40 contains a motor connected to the electronics of the printer 24, and controlled by the printer's software. Instead of a blade, also a milling cutter or a drill can be mounted to the blade holder 42, preferably interchangeable by means of an appropriate releasable connection.

FIG. 3 illustrates another use of the described printer 24. By insertion of a special ink cartridge, a further use of the printer would be possible. The ink is a security ink, as a chemical marker ink, an ink containing a luminescent substance, a UV fluorescent ink, a magnetic ink, a phosphorescent ink, or a photochromic ink. Thus, the printer 24 can be used for printing entry receipts 54 on the backs of the hands 52 of a visitor of a concert or a discotheque, as shown in FIG. 3.

It should be noted that other possible printing uses include postal franking and printing data onto the reverse of business cards. In this case, the printer would preferably be arranged to remain in the base station and an envelope or a business card is inserted into an appropriate one of a number of moulded guides. Typically the user would use a guide which positions an envelope for franking. An appropriate software would be running on the computer 10, assuring that the postage is paid (eg. via downloading a franking image from the internet upon payment via a credit card number), before a franking stamp is printed. The information printed onto the reverse of a business card would have some connection to the person mentioned on the front of this card.

FIG. 4 illustrates how a print cartridge 72 is mounted in the printer 24. A metal (or plastics) base plate 60 is mounted for scanning motion along the direction indicated by arrow A. The necessary mechanism for scanning in this direction is not shown in FIG. 4, for the sake of clarity. On the base plate 60, a first guide rail 62 is provided, and a second guide rail 64. Both guide rails 62,64 extend in a direction which is orthogonal to the direction of movement of the plate 60. Additionally, two wheels 78 are provided, around which a drive belt 66 is located. The drive belt 66 is preferably toothed and extends parallel to the guide rails 62,64. Further, a pin 70 is provided on a pin holder 68, the latter being fixed to the drive belt 66. The print cartridge 72 provided with an ink supply and nozzles for spitting the ink onto an image receiving medium is provided with four snap-on bearings 80, 82, 84 (the fourth one cannot be seen in FIG. 4—since it is hidden behind the cartridge 72—but is in the same plane as bearing 84 and fits onto guide rail 64). The bearings 80 and 82 are arranged to be snapped (or clipped) into the first guide rail 62, and the bearing 84 plus the hidden bearing are arranged to be snapped into the second guide rail 64. Thus, the cartridge 72 can be slidably fixed to the guide rails 62,64 and travel along the longitudinal axis of the guide rails. The pin 70 engages in a hole 86 of the cartridge, such that a driving connection between the drive belt 66 and the cartridge 72 is established. When the belt is driven (by means of a corresponding motor, not shown in FIG. 4 for the sake of clarity, but it could drive the belt 66 through the rectangular window in the base plate 60), the cartridge 72 travels along the guide rails 62,64. In order to control the print head of the cartridge 72, the printer's control electronics requires an information on the position of the print head. Thus, a pin wheel 74 engaging the printed medium is provided on the cartridge. The pin wheel rotates 74 when the cartridge 72 moves along the guide rails 62,64 and its rotation is detected by means of a motion detector 76. The pin 70 also carries the electrical connections (not shown) to both the print head and the motion detector 76. Pin wheel 74 is used to detect whether or not the printer is sufficiently close to the substrate to print accurately. If the wheel looses contact with the substrate, it stops revolving and the output signal from the motion detector 76 (which can employ a light barrier detecting the pins of the pin wheel 74) changes and printing is interrupted.

The base plate 60 and the pins on which the wheels 78 are mounted, and the guide rails 62,64 are unitary. Thus, the base plate 60 is produced as a unitary unit, eg. by die casting, in order to simplify construction and minimise component cost. It should be noted that a movement along the direction indicated by the arrow A is not necessary when the cartridge 72 contains a printhead having a width sufficient to print the entire image receiving medium in one scan.

FIG. 5 illustrates how scanning is performed over the image receiving medium. Most ink jet printers known in the prior art accelerate the print cartridge from rest to normal printing speed prior to firing the ink droplets. This simplifies the control of ink droplet spacing but the additional space required to accelerate the print cartridge increases the overall size of the product. The printer described here is hand held and thus requires that the overall dimensions are minimised. The control system of the print cartridge 72 thus provides the ability to print as the print cartridge assembly is accelerating—during printing of the left margin 90 of the image receiving medium 48′—and decelerating—during printing of the right margin 90′ of the image receiving medium 48′—at the start and finish of each sweep of the mechanism thus enabling the product dimensions to be minimized for a given size of the print area on the image receiving medium.

In FIG. 6, it is shown how features can be added to the cartridge 94 or the housing 92 of the cartridge 94 (ie. a holder in which the cartridge is accommodated) to aid alignment of the printer to the print area. These take the form of a pointer 98 or an indicator 96 attached to the print cartridge 94 or to the holder 92. The print cartridge may then be moved around the print area to indicate the maximum printable area.

FIG. 7 illustrates the printer 24 when placed on an alternative or modified base station 20′. The base station 20′ contains a supply 100 of labels 102 for printing upon. In order to prevent the ink cartridge from drying out should the printer 24 not be returned to the base station 24, a sealing lid 108 is attachable to the printer to close the print aperture in the base of the printer. A hermetically sealable compartment is also provided in the base station 20′ (not shown). This provides storage for a partially used cartridge to prevent it from drying out, for example if different colour cartridges are used. The printer 24 of FIG. 7 has some features for making alignment on the image receiving medium easier: on the top of the housing of the printer, two small windows 104 are located, which allow to see and align the image receiving medium with respect to the printer (or the other way around).

Reference is made to FIG. 8 which schematically shows the computer of FIG. 1 and the printer.

The computer 200 comprises a display 202 which can be used to display the information which is to be printed. However, this is not necessary and in some embodiments of the present invention, the display may be off, display something else or even omitted. The computer 200 also has a processor 204 which controls the display and indeed the printer. The processor 204 may receive information from a user interface 206 such as a keyboard or similar device. This allows the user to control the function of the computer 200. The processor 204 may receive information from an external interface 208 which may be a modem or the like. The external interface 208 may provide a connection to the Internet. One or other of the interfaces may be omitted. The external interface may provide the information which is to be printed or may control the processor 204. The processor may send information to an external location via the external interface 208.

In this embodiment of the present invention, the connection between the computer and the printer is via a wireless connection. In preferred embodiments of the present invention the connection is a Bluetooth connection. Bluetooth is a proposed standard which provides low power, high frequency connections. Typically, the frequency used is of the order of Gigahertz. The power of the transmission are such that the signals have a relatively short range, perhaps only a few metres or less or tens of metres. The Bluetooth standard permits a wireless connection to be set up between two transceivers without requiring any other element. Bluetooth has the advantage that the signals are omnidirectional.

In alternative embodiments of the present invention, other frequencies for the signal can be used. For example infrared signals can be used.

So that the computer can communicate with the printer, a transceiver 210 is provided. The transceiver 210 is arranged to put the data to be transmitted into a suitable format so that it can be transmitted by an antenna 212. The transceiver also processes the signals which are received from the antenna into a format which can be used by the processor.

The printer 214 can take the same form as the printer previously described and may therefore be provided with a base station. In alternative embodiments of the present invention, the base station may be omitted. The connection between the printer and the computer may be between the computer and the base station, or between the computer and the printer.

The printer 214 is provided with an antenna 216 which receives information from the computer and transmits information to the computer 200. The antenna is connected to a transceiver 218 which will be described in more detail in relation to FIG. 9. The transceiver is connected to a processor 220 which controls the printer and provides the printer part 222 of the printer with the data to be printed, In some embodiments the processor may be omitted if the printer is a dumb printer and completely controlled by the computer.

Where a base station is provided, the connection between the base station and the printer may be a wired or a wireless connection.

Reference will now be made to FIG. 9 which shows in more detail the structure the transceiver 210 of the computer and the transceiver 218 of the printer. The transceiver is arranged to receive signals from the antenna. A duplex filter 224 (which may be tunable) is provided which directs the signals received to a down converter 226. The signals which are received are at a high frequency and need to be down converted to the base band frequency. The signals also need to be converted from analogue signals to digitals signals, demodulated and decoded. These will be done by the down converter 226 in conjunction with a processor 228. This may be the same or different to the processor provided in the printer or the computer. Other processing of the signals may take place. The order in which the various operations are performed is a matter of design choice.

Similarly, signals to be transmitted are processed by a processor 230 in conjunction with an upconverter 232. The signals are upconverted from the base band frequency to the radio frequency. The base band signals are digital and the radio frequency signals are analogue. The signals are also modulated and encoded before being transmitted. The signals to be transmitted are output to the antenna via the duplex filter 224.

In preferred embodiments of the invention, the printer receives the data to be printed from the computer via the wireless connection. The data can take any suitable format.

The data can be at least partly defined by the user who interacts with the computer via the user interface.

The data can be at least partly defined by data received from the external interface. For example, the printer can be advantageously be used to frank mail or stamp mail. To achieve this a connection would be established via the external interface with a third party authorised to provide the equivalent of an electronic stamp or frank. The electronic stamp or frank can then be applied by the printer and the user's account with the third party could be debited accordingly.

Reference will now be made to FIG. 10 which shows the screens used to design one or more stamps in an alternative embodiment of the present invention. In this embodiment, the printer 24 is not linked to the computer but rather is a standalone device. As the printer 24 is not connected to the computer 10, the printer 24 or its base is provided with a memory card, smart card, memory chip or the like. This memory card or the like is arranged to store at least one and preferably several stamps. These stamps may for example allow the user to stamp their address onto products, stamp correspondence with the date the correspondence was received or the like. In order to generate these stamps, the user is provided with software which can be used in conjunction with a PC. This software is described in relation in FIG. 10. This software allows the stamps to be designed.

FIG. 10A shows the first screen which is displayed to the user. This allows the user to design up to six stamps 300. To modify or design one of these stamps 300, the user double clicks on one of the stamps. The user can open an existing stamp set by clicking on area 301 or create a new stamp set by clicking on area 303. From this screen the user can print a proof set by clicking on area 299 and save the set by clicking on area 298.

In FIG. 10B, the next screen which is displayed when the user clicks on one of the labels is shown. This screen has an area 302 where the stamp's current format is displayed. In the case of a new stamp, this area 302 is clear. However, if the user is editing a previous stamp, then that current version of the stamp is shown. To get to the next menu the user clicks on area 304.

The third screen which is displayed is shown in FIG. 10C. Again, the third screen has the area 302 which shows any of the characteristics of the new or existing stamp. This screen allows the user to input a background to the stamp. This is done by selecting a desired background using menu 306. The user can select no background. Alternatively, the user can insert any desired background. In alternative embodiments of the present invention, the menu may provide a number of options for different backgrounds that can be provided. The background may have the name of the company in a shadow-like font, provide a grey background or background graphic or the like. The user then clicks on the are 304 to get to the next screen.

The next screen displayed is shown in FIG. 10D. This screen again has the preview area 302. This screen is to allow the user to add a graphic image to the stamp. For example, a company logo or other graphic can be included in a area of the stamp. This graphic can be moved anywhere in the stamp area and can be resized. Graphics are added by clicking on area 310. If the stamp already contains a graphic, the user can use this screen to remove that graphic by clicking on the area 312 of the screen. To get to the next screen, the user clicks on the area 304.

The next screen which is displayed is shown in FIG. 10E. Using this screen, the user can add text to the stamp, such as a message, address or any other information. To add text, the user clicks on the area 314 of the display. If text is displayed the user is able to delete text by clicking on area 315. The text can be added anywhere to the stamp and can be resized. To change the font for any part of the text, the are 316 is selected. For the add text and change text function, a box is displayed when these functions are selected in which the text can be entered or altered.

To get to the next screen, the user clicks on the area 304 of the screen. This next screen is shown in FIG. 10F. This screen allows the user to add the date, time or both to the stamp. This is a useful feature for example when recording the date when a piece of correspondence is received. To select the desired format and information, a dropdown menu 320 is provided. This includes the option of not having any date or time and various different formats for the date and time. The user can select the required format. When the stamp is actually used, the current date and time will replace the example shown in the dropdown menu 320. To get to the next screen, the user again clicks on the area 304.

The next screen which is displayed is shown in FIG. 10G which allows the user to add a counter to the stamp. The counter can be used to number stamped items either in ascending or descending order. Using the menu 322, the user is able to select whether or not to have a counter and the format of the numbers which are printed. There is an option 324 which allows the user to select an initial count value. There is also an option 326 which allows the user to determine whether to count by 1, 2 etc. The count up and count down options 328 allow the user to select an incrementing or decrementing counter.

In the final screen shown in FIG. 10H which is displayed, the final version of the stamp is previewed. The user is able to print a sample of that stamp using a conventional printer by clicking on the print proof area 330. Using the previous area 332 on the screen, the user is able to revert to a previous screen. This previous area is provided on each of the screens with the exception of the first and second screens. The final screen also has an area 336 in which the user can insert a name for the stamp. The user is then able to carry out similar steps for each of the other stamps. When the user has completed all of the stamps, the user is able to save the stamp set.

The saved stamp set is then forwarded via the internet to a remote computer or server. That remote computer is arranged to receive the data and download the stamp data onto a memory card, chip or like. That memory card, chip or the like is then sent, for example by mail or the like, to the user and can then be inserted in the printer 24.

In a preferred embodiment of the present invention, the data is automatically formatted into a message which can be sent via the internet to the remote computer. This message may be formulated and sent when for example the user saves the stamp set. Alternatively, the user may have another option “send stamp sent” which would send the stamp set when selected. The user may be required to confirm that he wishes to send the stamp set. The message which would be automatically formulated would include the relevant details of the user and the address to which the stamp set is to be sent as well as the stamp set itself.

In an alternative embodiment of the present invention, the printer may be temporarily linked to the computer via a cable 10, Bluetooth connection or the like. The stamp or stamp set is then downloaded to the printer. The connection between the printer 24 and the computer can then be severed and the printer can operate as a standalone printer.

It should be appreciated that this last described embodiment may be modified to provide any of the appropriate features of the printer discussed previously. The method used to design the stamp sets shown in FIG. 10 can be used in any of the described embodiments.

In another embodiment of the invention, the printer may be arranged to print the date and/or time. This information may be provided from the computer itself or via the external interface.

In another embodiment of the invention, the printer may be arranged to print incremental data. In other words a serial number or the like may be incremented each time the printer is used. The information as to the next number to be printed is provided from the computer. Again the information may be from the computer itself or from the external interface.

The printer can be arranged to print bar codes. These bar codes may or may not represent incrementing numbers. The bar code to be printed is provided by the computer which may get the required information from the external interface.

In embodiments of the present invention, the printer has been described as establishing a connection with a computer. However, in alternative embodiments of the present invention, the printer may be arranged to receive the data to be printed from any other suitable device.

A mixture of different types of data may be printed. For example an address and frank may be printed on an envelope or a bar code along with a product description.

In the described embodiments of the present invention, the printer has been described as having a scanning print mechanism. In alternative embodiments, the print mechanism can be fixed.

In alternative embodiments of the present invention, the printer itself may be relatively sophisticated and may have an external interface which permits it to connect to the Internet or the like to receive the required information.

The transceiver of the printer 214 may be arranged so that it only receives information from the computer. However in preferred embodiments of the present invention the printer transceiver is arranged also to be able to transmit as this assists in the establishment of a connection between the computer and the printer. The printer may also be able to transmit acknowledgments or indications that part or all of the data needs to be resent.

The printing mechanism need not be an ink jet print head but could be any other type of print mechanism.

1. A printer comprising:
a printing mechanism arranged to print an image on an image receiving medium;
wireless receiver means for receiving image data for printing on said image receiving medium, wherein said wireless receiver means is arranged to receive signals having a frequency of the order of Gigahertz.

2. A printer as claimed in claim 1, wherein said signals are Bluetooth signals.

3. A printer as claimed in claim 1 or 2, wherein said wireless receiver means is arranged to receive time and/or date information for printing on said image receiving medium.

4. A printer as claimed in claim 1, 2 or 3, wherein wireless receiver means is arranged to receive bar code information for printing on said image receiving medium.

5. A printer as claimed in any of claims 1 to 4, wherein said wireless receiver means is arranged to receive serial information for printing on said image receiving medium.

6. A printer as claimed in any preceding claim, wherein said wireless receiver means is arranged to receive postage information or a frank for printing on said image receiving medium.

7. A printer comprising:
a printing mechanism arranged to print an image on an image receiving medium;
wireless receiver means for receiving image data for printing on said image receiving medium, wherein said wireless receiver means is arranged to receive signals in accordance with the Bluetooth standard.

8. A printer comprising:
a printing mechanism arranged to print an image on an image receiving medium;
wireless receiver means for receiving image data for printing on said image receiving medium, wherein said wireless receiver means is arranged to receive time and/or date information for printing on said image receiving medium.

9. A printer comprising:
a printing mechanism arranged to print an image on an image receiving medium;
wireless receiver means for receiving image data for printing on said image receiving medium, wherein said wireless receiver means is arranged to receive bar code information for printing on said image receiving medium.

10. A printer comprising:
a printing mechanism arranged to print an image on an image receiving medium;
wireless receiver means for receiving image data for printing on said image receiving medium, wherein said wireless receiver means is arranged to receive serial information for printing on said image receiving medium.

11. A printer comprising:
a printing mechanism arranged to print an image on an image receiving medium;
wireless receiver means for receiving image data for printing on said image receiving medium, wherein said wireless receiver means is arranged to receive postage information or a frank for printing on said image receiving medium.

12. A printer as claimed in a claim 6 or 11, wherein said receiver means is arranged to receive an address for printing on said image receiving medium.

13. A printer as claimed in any preceding claim, wherein said printer comprises a housing arranged to be manually positioned on the image receiving medium, said print mechanism being arranged to be provided in said housing.

14. A printer as claimed in claim 13, wherein said printer comprises at least one surface provided on the housing, said surface being arranged to contact the image receiving medium during printing, with said printing mechanism being in contact with said image receiving medium.

15. A printer as claimed in any preceding claim, comprising a scanning means for causing the printing mechanism to be moved relative to said image receiving medium.

16. A printer as claimed in any of claims 1 to 15, wherein said printing mechanism is fixed relative to said printer.

17. A printer as claimed in any preceding claim, wherein said printer further comprises wireless transmitting means for transmitting information.

18. A printer as claimed in any preceding claim, wherein said printer is a hand held printer.

19. A printer as claimed in any preceding claim, wherein said printer is, in use, put in contact with said image receiving medium.

20. A system comprising a printer as claimed in any preceding claim and a computer device, said computer device comprising wireless transmission means for transmitting to said receiving means of said printer.

21. A system as claimed in claim 20, wherein said computer device comprises an external interface for receiving information for transmission to said printer.

22. A system as claimed in claim 21, wherein said external interface is arranged to connect said computer to the Internet.
computer connected to the network for receiving from the at least one user information defining said stamps; memory means coupled to said server computer for receiving said at least one stamp.

24. A server computer for use in a system for providing a user with memory means for use in a standalone printer, said server computer being arranged to be connected to a network to receive from a user information defining at least one stamp, said server computer having means for coupling said computer to memory means so that information defining said at least one stamp can be loaded into said memory means.

25. A method for providing a user with memory means for use in a standalone printer, said method comprising:
using a computer connected to a network to design at least one stamp to be used with said standalone printer;
sending to a server computer connected to the network information defining said at least one stamp;
loading information defining said at least one stamp into memory means and sending said memory means to said user.

26. A method as claimed in claim 25, wherein said network comprises the Internet.

27. A method as claimed in claim 25 or 26, wherein said memory means comprises a memory card, smart cart or memory chip.
